(19) United States
(12) Patent Application Publication
(10) Pub. No.: US 2010/0074988 A1
(43) Pub. Date: Mar. 25, 2010

(54) CENTER-FILLED COATED GUM AND A METHOD OF ITS PREPARATION

(75) Inventors: Jin Kyung Jeon, Seoul (KR); Chi Geol Park, Gyonggi-do (KR); Man Chong Lee, Gyeonggi-do (KR); Yong Tack Kim, Seoul (KR)

Correspondence Address: Fleit Gibbons Gutman Bongini & Bianco PL, 21355 EAST DIXIE HIGHWAY, SUITE 115, MIAMI, FL, 33180, US

(73) Assignee: Lotte Confectionery Co., Ltd., Seoul (KR)

(21) Appl. No.: 12/525,610

(22) PCT Filed: Oct. 30, 2007
(86) PCT No.: PCT/KR2007/005380

§ 371 Date: Aug. 3, 2009

(30) Foreign Application Priority Data
Feb. 6, 2007 (KR) 10-2007-0012081

(51) Int. Cl. A23G 4/20; A23G 4/06

(52) U.S. Cl. 426/5

(57) ABSTRACT

The present invention relates to a center-filled coated chewing gum giving a feeling of refreshment and a preparation method thereof, and particularly to a chewing gum comprising a center layer filled with paste or granules with a predetermined size, a gum base layer surrounding the center layer and a coating layer surrounding the outer surface of the gum base layer, thereby enabling to prevent the ingredients of the center layer from being sunk into the gum base layer by limiting the temperature and humidity range when applying the coating onto the gum base layer surrounding the center layer, and also to provide a superior feeling of refreshment and crunch as compared to the conventional chewing gum comprising a liquid-phase or powder-phase center layer, and a preparation method thereof.

### TECHNICAL FIELD

The present invention relates to a center-filled coated chewing gum giving a feeling of refreshment and a preparation process thereof.

### BACKGROUND ART

The conventional chewing gum is prepared by completely mixing sugar and sugar alcohols or other sweetener as a main ingredient along with small amount of other food or food additives such as a gum base, an emulsifying agent, a softening agent and a flavor in a pre-heated mixer, and performing extrusion, rolling and aging for 24-28 hours, followed by cutting and packing processes. The conventional center-filled gum is prepared by filling a sweetener, an organic acid and a flavor into the center of the chewing gum after mixing the aforementioned materials, followed by processes of molding and aging for 24-48 hours.

Further, WO 2006/ 026298 discloses a center-filled chewing gum, whose center is filled with a liquid-phase material. U.S. Pat. No. 4,513,012 discloses a center-filled chewing gum, a center of which is filled with powder-phase material. Other center-filled chewing gums disclosed are prepared by filling a sweetener and an organic acid and a flavor in the center of the chewing gum.

These conventional gums are prepared by using a crystalline material to facilitate the filling the center of the chewing gum, optionally in combination with L-menthol to increase a feeling of refreshment. However, the crystalline material decreases the touch inside the mouth and preference, and the use of L-menthol is also very limited because of its peculiar flavor and bitterness when used in large amount.

Although sugar alcohols with latent heat such as sorbitol and xylitol have also been used, they show a relatively high hydroscopic property and causes serious problems during the manufacture of chewing gums.

Further, the conventional chewing gums comprise either a center-filled or a coating layer, and the characteristics of both gums could have been tasted by chewing each of the gums separately.

### DISCLOSURE

### Technical Problem

The present inventors have exerted extensive researches to overcome the aforementioned problems and also to develop a chewing gum giving both a feeling of refreshment and a feeling of crunch. As a result, the present invention is finally completed based on the findings that a feeling of refreshment may be maximized by preparing a composition for filling a center with paste or granules with a predetermined diameter, and that the composition for filling a center does not sink into the gum base layer and a feeling of crunch may be appropriately achieved by limiting the range of temperature and humidity when forming a coating layer onto the outer surface of the gum base layer.

Therefore, the present invention aims to provide a center-filled chewing gum, which is filled with a paste-phase or a granule-phase (with a predetermined diameter) composition for filling the center and comprises a coating layer.

Further, the present invention also aims to provide a process of preparing a chewing gum, where the range of temperature and humidity is limited when forming a coating layer onto the outer surface of the gum base layer.

### Technical Solution

The present invention relates to a center-filled coated chewing gum comprising a center layer containing paste or granules with a diameter of 10-18 mesh, a gum base layer surrounding the center layer and a coating layer surrounding the outer surface of the gum base layer.

Further, the present invention also relates to a process of preparing center-filled coated chewing gum, which comprises (a) obtaining a mixture by mixing a gum base layer composition comprising a gum base, a sweetener and a sugar alcohol in a mixer pre-heated at 45-55° C., adding a flavor in the composition and further mixing a mixture comprising the composition and the flavor; (b) obtaining a molded gum by extruding the mixture with an extruder, hoppering paste-phase or granule-phase xylitol composition through a hopper with a screw, whereby enabling the filling of the center and the molding; and, (c) coating the molded gum with a coating layer composition under the conditions of 18-25° C. and 40-50% RH, followed by aging.

Hereunder is provided a detailed description of the present invention.

The present invention relates to a chewing gum comprising a center layer filled with paste or granules with a predetermined size, a gum base layer surrounding the center layer and a coating layer surrounding the outer surface of the gum base layer, thereby enabling to prevent the ingredients of the center layer from being sunk into the gum base layer by limiting the temperature and humidity range when applying coating onto the gum base layer surrounding the center layer, and also to provide a superior feeling of refreshment and crunch as compared to the conventional chewing gum comprising a liquid-phase or powder-phase center layer, and a preparation method thereof.

Hereunder is provided a detailed description of a center-filled coated chewing gum according to the present invention.

A center-filled coated chewing gum herein comprises paste-phase or granule-phase center layer, a gum base layer surrounding the center layer and a coating layer surrounding the outer surface of the gum base layer.

The center-filled coated chewing gum may comprise 5.0-30.0 wt % preferably 10-25 wt % of a center layer, 30.0-80.0 wt % preferably 55-70 wt % of a gum base layer and 10.0-40.0 wt % preferably 10-30 wt % of a coating layer.

When the content of the center layer is less than 5.0 wt %, a feeling of refreshment may not be sufficient. When the content is higher than 30.0 wt %, the gum may become soft and the center layer may easily flow out during the coating process due to a relatively high amount of sugar alcohol.

When the content of the gum base layer is less than 30.0 wt %, it may not function as a gum. When the content is higher than 80.0 wt %, a feeling of refreshment may not be satisfactory due to insufficient filling of the center layer.

When the content of the coating layer is less than 10.0 wt %, a feeling of crunch, a characteristic of coating, may decrease. When the content is higher than 40.0 wt %, the sense of touch during chewing may not be satisfiable due to the relatively thick coating layer.

The gum base layer may comprise 15-50 wt % of a gum base, 45-80 wt % of a sugar alcohol and sweetener and 0.1-5.0 wt % of a flavor. Any conventional gum base may be used in the present invention. In particular, polyvinyl acetate with a high degree of polymerization is preferred in the sense that a center layer does not easily sink into the gum base.

Examples of the sugar alcohol include xylitol, maltitol, sorbitol, erythritol, isomalt, lactitol, mannitol and a mixture thereof. Examples of the sweetener include sugar, glucose, starch syrup and a mixture thereof.

The center layer may comprise 60-99 wt % of xylitol, 0-5.0 wt % of a cooling agent, 0.1-25 wt % of water, 0-5.0 wt % of menthol and 0-5.0 wt % of a flavor. Examples of the cooling agent include monomenthyl succinate, 1-menthyllacetate and menthol carboxamide. Flavor may be selected to taste.

In particular, the center layer comprises paste-phase or granule-phase. The paste-phase center layer is preferred to contain less water than the conventional paste. The granule-phase center layer is preferred to have a diameter of 10-18 mesh, preferably 12-16 mesh. When the mesh size of the granules is lower than 10 mesh, a feeling of refreshment may not be satisfactory due to insufficiency in filling. When the mesh size is larger than 18 mesh, a feeling of refreshment may not be satisfactory due to the small particle size of the granules.

The coating layer may comprise 60-95 wt % of sugar alcohol, 0.1-5.0 wt % of a binding agent, 1.0-30 wt % of water and 0.1-5.0 wt % of a flavor. Examples of the sugar alcohol include xylitol, maltitol, sorbitol, erythritol, isomalt, lactitol, mannitol and a mixture thereof. Examples the binding agent include gums, preferably Arabic gum, and gelatin.

Hereunder is provided a detailed description of each step of a process according to the present invention.

In a step, a mixture is obtained by mixing a gum base layer composition comprising a gum base, a sweetener and a sugar alcohol in a mixer pre-heated at 45-55° C., adding a flavor in the composition and further mixing a mixture comprising the composition and the flavor.

The flavor is added later to prevent the photo-decomposition of the flavor. In particular, when polyvinyl acetate with a relatively high degree of polymerization is used as a gum base, the flowing-out of a center layer may be decreased during the coating process, thus increasing the quality of goods.

In another step, a molded gum is obtained by extruding the mixture with an extruder, hoppering paste-phase or granule-phase xylitol composition through a hopper with a screw, whereby enabling the filling of the center and the molding; and,

In particular, liquid nitrogen (−196° C.) is preferred to be used to prevent the adhesion of the gum to the mold.

In still another step, the molded gum is coated with a coating layer composition under the conditions of 18-25° C. and 40-50% RH, followed by aging.

A center-filled coated chewing gum herein is superior to the conventional chewing gum comprising a liquid-phase or powder-phase center layer in both a feeling of refreshment and a feeling of crunch.

Further, the sinking of ingredients contained in a center layer into a gum base layer is prevented in the present invention by improving the conditions, i.e. by limiting the temperature range to 18-25° C. and the humidity range to 40-50% RH when applying the coating onto the gum base layer surrounding the center layer.

### Advantageous Effects

As described above, the present invention provides a chewing gum giving both a feeling of refreshment and a feeling of crunch.

### MODE FOR INVENTION

The present invention is described more specifically by the following Examples. Examples herein are meant only to illustrate the present invention, but in no way to limit the claimed invention.

### Example 1

### Preparatory Example 1

### Preparation of Gum Base Mass

Gum base mass was prepared by using a predetermined amount of ingredients as shown in Table 1. Ingredients except flavor were completely mixed in a mixer, which was preheated at 45-55° C., for about 30 minutes, followed by cooling. The cooled mixture was added with flavor, thus providing gum base mass.

TABLE 1

| | | | Content (wt %) | | | |
|---|---|---|---|---|---|---|
| | | | Specimen 1 | Specimen 2 | Specimen 3 | Specimen 4 |
| Ingredient | Gum base¹⁾ | | 32 | 32 | 32 | 27 |
| | Sugar | Xylitol | 66 | 36 | — | — |
| | alcohol | Maltitol | — | 30 | — | — |
| | | Sorbitol | — | — | 10 | — |
| | | Erythritol | — | — | 36 | — |
| | | Isomalt | — | — | 10 | — |
| | | Lactitol | — | — | 5 | — |
| | | Mannitol | — | — | 5 | — |
| | Sweetener | Sugar | — | — | — | 55 |
| | | Starch syrup | — | — | — | 7 |
| | | Glucose | — | — | — | 8 |

| | | | | |
|---|---|---|---|---|
| Emulsifying agent²⁾ | 0.5 | 0.5 | 0.5 | 0.5 |
| Flavor³⁾ | 1.5 | 1.5 | 1.5 | 1.5 |
| Coloring agent⁴⁾ | — | — | — | 0.5 |
| Liquid-phase sorbitol | — | — | — | 0.5 |

| | | | | |
|---|---|---|---|---|
| Total | 100 | 100 | 100 | 100 |

¹⁾Cultor, Roquette
²⁾Mitsubishi
³⁾Fruit flavor, Mint flavor
⁴⁾Lotteshopping Co. Ltd., MSC

### Preparatory Example 2

### Preparation of Paste for Filling Center

Menthol was dissolved in a double boiler by using a predetermined amount of ingredients as shown in Table 2. Menthol and cooling agent were mixed by adding ethanol to a cooling agent. Water was added to xylitol. Paste for filling a center was prepared by mixing the mixture of menthol and cooling agent with the xylitol containing water with a homogenizer. Water content in the paste was determined according to the Karl Fischer method, and the results are presented in Table 2.

TABLE 2

| | | Content (wt %) | | |
|---|---|---|---|---|
| | | Specimen 5 | Specimen 6 | Specimen 7 |
| Ingredients | Xylitol | 95 | 95 | 95 |
| | Cooling agent¹⁾ | 1 | — | — |
| | Menthol | 1 | 1 | — |
| | Water | 2 | 3.5 | 5 |
| | Ethanol | 1 | 0.5 | — |

| | | | |
|---|---|---|---|
| Total | 100 | 100 | 100 |
| Water content (%) | 1.0 | 2.0 | 3.0 |

¹⁾Symrise, Givaudan, Firmenich

### Preparatory Example 3

### Preparation of Granules for Filling Center

Menthol was mixed with a cooling agent by using a predetermined amount of ingredients as shown in Table 3. The mixture was mixed with xylitol for 20 minutes in a granule mixer, while adding water. Granules were prepared by passing the mixture through a granulator (12 mesh), followed by drying at room temperature for 24 hours, thus obtaining granules for filling a center. Average diameter of the granules is presented in Table 3.

TABLE 3

| | | Content (wt %) | | | | |
|---|---|---|---|---|---|---|
| | | Specimen 8 | Specimen 9 | Specimen 10 | Specimen 11 | Specimen 12 |
| Ingredients | Xylitol | 95 | 95 | 96 | 96 | 95 |
| | Cooling | 0.5 | 1 | 1 | 1 | 0.5 |
| | agent¹⁾ | | | | | |
| | Menthol | 2.5 | 1.5 | 1 | 1 | 0.5 |
| | Water | 2 | 1.5 | 1 | 1 | 2 |
| | Powder | — | 1.0 | 1 | 1 | 2 |
| | flavor | | | | | |

| | | | | | |
|---|---|---|---|---|---|
| Total | 100 | 100 | 100 | 100 | 100 |
| Diameter (mesh) | 8 | 10 | 16 | 16 | 18 |

¹⁾Symrise, Givaudan, Firmenich

### Preparatory Example 4

### Preparation of Composition for Coating

Arabic gum was dissolved in a double boiler by using a predetermined amount of ingredients as shown in Table 4. The Arabic gum was mixed with xylitol and water in a syrup mixer until completely dissolved, thus obtaining a composition for coating.

TABLE 4

| | | | Content (wt %) | | | |
|---|---|---|---|---|---|---|
| | | | Specimen 13 | Specimen 14 | Specimen 15 | Specimen 16 |
| Ingredients | Sugar | Xylitol | 68.6 | — | 68.6 | — |
| | alcohol | Maltitol | — | 60.9 | — | — |
| | | Sorbitol | — | — | — | — |
| | | Erythritol | — | — | — | — |
| | | Isomalt | — | — | — | 66.5 |
| | | Lactitol | — | — | — | — |
| | | Mannitol | — | — | — | — |
| | Binding | Arabic gum | 4.1 | 3.6 | 1.7 | 3.5 |
| | agent | Gelatin | — | — | 2.3 | — |

| | | | | |
|---|---|---|---|---|
| Water | 27.3 | 35.5 | 27.4 | 30 |

| | | | | |
|---|---|---|---|---|
| Total | 100 | 100 | 100 | 100 |

### Examples 1-3

### Preparation of Center-Filled Coated Chewing Gum

A center-filled coated chewing gum was prepared by using a predetermined amount of ingredients as shown in Table 5. A gum base was prepared by mixing a gum base material, xylitol, a flavor and an emulsifying agent for 30 minutes at 50° C. The gum base was passed through an extruder, while continuously hoppering paste for a center layer into the center of the gum base through a hopper. At the same time, the gum base containing the paste was passed through a mold, thereby maintaining the shape of a center-filled chewing gum.

Liquid nitrogen (−196° C.) was used to prevent the adhesion of the gum base containing paste to the mold. The gum base containing paste (42 kg) was placed in a pan under the conditions of 20° C. and 50% RH for the coating process, and the coating process was repeated 24 times. The coated gum was treated with a coating agent for improving the surface gloss.

TABLE 5

| | | Content (wt %) | | | |
|---|---|---|---|---|---|
| | | Ex. 1 | Ex. 2 | Ex. 3 | Ex. 4 |
| Gum base layer | Specimen 1 | 63.4 | — | — | — |
| | Specimen 2 | — | 66.7 | — | — |
| | Specimen 3 | — | — | 66.7 | — |
| | Specimen 4 | — | — | — | 66.7 |
| Center layer | Specimen 5 | 21.2 | — | — | 16.3 |
| | Specimen 6 | — | 16.3 | — | — |
| | Specimen 7 | — | — | 16.3 | — |
| Coating layer | Specimen 13 | 15.1 | — | — | — |
| | Specimen 14 | — | 16.3 | — | — |
| | Specimen 15 | — | — | 16.3 | — |
| | Specimen 16 | — | — | — | 16.3 |

| | | | | |
|---|---|---|---|---|
| Total | 100 | 100 | 100 | 100 |

### Examples 5-9 and Comparative Examples 1-2

### Preparation of Center-Filled Coated Chewing Gum

A center-filled coated chewing gum was prepared by using a predetermined amount of ingredients as shown in Table 6. A gum base was prepared by mixing a gum base material, xylitol, a flavor and an emulsifying agent for 30 minutes at 50° C. The gum base was passed through an extruder, while continuously hoppering size-controlled granules for a center layer into the center of the gum base through a hopper. At the same time, the gum base containing the granules was passed through a mold, thereby maintaining the shape of a center-filled chewing gum.

Liquid nitrogen (−196 ° C.) was used to prevent the adhesion of the gum base containing granules to the mold. The gum base containing granules (42 kg) was placed in a pan under the conditions of 20° C. and 50% RH for the coating process, and the coating process was repeated 24 times. The coated gum was treated with a coating agent for improving the surface gloss.

TABLE 6

| | | Content (wt %) | | | | | | |
|---|---|---|---|---|---|---|---|---|
| | | | | | | | Comp. | Comp. |
| | | Ex. 5 | Ex. 6 | Ex. 7 | Ex. 8 | Ex. 9 | Ex. 1 | Ex. 2 |
| Gum base layer | Specimen 1 | 66.7 | — | — | — | 66.37 | 66.7 | 66.7 |
| | Specimen 2 | — | 66.7 | — | — | — | — | — |
| | Specimen 3 | — | — | 66.7 | — | — | — | — |
| | Specimen 4 | — | — | — | 66.7 | — | — | — |
| Center layer | Specimen 8 | — | — | 13.3 | — | — | 16.7 | — |
| | Specimen 9 | — | 16.7 | — | — | — | — | — |
| | Specimen 10 | 16.7 | — | — | — | — | — | — |
| | Specimen 11 | — | — | — | 16.7 | — | — | — |
| | Specimen 12 | — | — | — | — | 16.7 | — | 16.7 |
| Coating layer | Specimen 13 | 16.7 | — | — | — | 16.7 | 16.7 | 16.7 |
| | Specimen 14 | — | 16.7 | — | — | — | — | — |
| | Specimen 15 | — | — | 20 | — | — | — | — |
| | Specimen 16 | — | — | — | 16.7 | — | — | — |

| | | | | | | | |
|---|---|---|---|---|---|---|---|
| Total | 100 | 100 | 100 | 100 | 100 | 100 | 100 |

### Comparative Example 3

### Preparation of Uncoated Liquid-Phase Center-Filled Chewing Gum

Maltitol syrup was prepared by mixing a flavor, menthol and a liquid-phase maltitol. A gum base was prepared by mixing a gum base material, xylitol, a flavor and an emulsifying agent for 30 minutes at 50° C. An uncoated liquid-phase center-filled chewing gum containing 18 wt % of the malitol syrup was prepared by passing the gum base through an extruder, while continuously hoppering the maltitol syrup into the center of the gum base through a hopper. At the same time, the gum base was passed through a mold, thereby maintaining the shape of a center-filled chewing gum. Liquid nitrogen (−196° C.) was used to prevent the adhesion of the gum base to the mold.

### Comparative Example 4

### Preparation of Uncoated Powder-Phase Center-Filled Chewing Gum

A gum base was prepared by mixing a gum base material, xylitol, a flavor and an emulsifying agent for 30 minutes at 50° C. An uncoated powder-phase center-filled chewing gum containing 18 wt % of powders of xylitol and erythritol was prepared by passing the gum base through an extruder, while continuously hoppering xylitol powders and erythritol powders into the center of the gum base through a hopper. At the same time, the gum base was passed through a mold, thereby maintaining the shape of a center-filled chewing gum. Liquid nitrogen (−196° C.) was used to prevent the adhesion of the gum base to the mold.

### Experimental Example

Sensory tests about each item below were conducted by 20 panels by using the chewing gums prepared in Examples 1-9 and Comparative Examples 1-4, and the results are presented in Table 7.

TABLE 7

| | | | | | | | | | | Comparative | | | |
|---|---|---|---|---|---|---|---|---|---|---|---|---|---|
| | Examples | | | | | | | | | Examples | | | |
| | 1 | 2 | 3 | 4 | 5 | 6 | 7 | 8 | 9 | 1 | 2 | 3 | 4 |
| Touch inside | 5 | 5 | 5 | 4 | 5 | 5 | 5 | 4 | 5 | 5 | 5 | 5 | 5 |
| mouth¹⁾ | | | | | | | | | | | | | |
| Feeling of | 3 | 3 | 3 | 2 | 5 | 3 | 3 | 2 | 2 | 3 | 3 | 3 | 3 |
| refreshment²⁾ | | | | | | | | | | | | | |
| Bitter taste²⁾ | 2 | 2 | 2 | 2 | 1 | 3 | 3 | 2 | 2 | 3 | 4 | 4 | 3 |
| Feeling of | 3 | 4 | 3 | 3 | 3 | 3 | 4 | 3 | 3 | 3 | 3 | 1 | 1 |
| crunch²⁾ | | | | | | | | | | | | | |
| Preference¹⁾ | 3 | 3 | 3 | 2 | 5 | 4 | 3 | 2 | 3 | 3 | 2 | 2 | 3 |

¹⁾Touch inside mouth and preference
5: Very good, 4: Good, 3: Average, 2: Bad, 1: Very bad
²⁾Feeling of refreshment, bitter taste and feeling of crunch
5: Very strong, 4: Strong, 3: Average, 2: Weak, 1: Very weak

As shown in Table 7, the chewing gums, which are prepared in Examples 5-9 by filling the center with the granules with a diameter of 8-18 mesh in the center prepared in Preparatory Examples 8-12, show remarkably superior sensory characteristics. Further, the chewing gums, which are prepared in Examples 1-4 by filling the center with the paste prepared in Preparatory Examples 5-7, show better sensory characteristics than the conventional chewing gum filled with liquid-phase or granule-phase material, although they do not those in Examples 5-9.

Further, although it is not shown in the tables, chewing gums prepared in Examples 1-9 showed no sinking of the ingredients filled in the center layer into the gum base layer, which is achieved by limiting the water content in the center layer to less than 1.0% and controlling the size of granules within 10-18 mesh.

### INDUSTRIAL APPLICABILITY

The present invention relates to a center-filled coated chewing gum giving a feeling of refreshment and a preparation method thereof. As described above, the present invention provides a chewing gum giving both a feeling of refreshment and a feeling of crunch.

1. A center-filled coated chewing gum comprising (i) a center layer filled with paste or granules with a diameter of 10-18 mesh comprising 60-99 wt % of xylitol, 0-5.0 wt % of a cooling agent, 0.1-25 wt % of water, 0-5.0 wt % of menthol and 0-5.0 wt % of a flavor, (ii) a gum base layer surrounding the center layer, and (iii) a coating layer surrounding an outer surface of the gum base layer.

2. The chewing gum of claim 1, which comprises (i) 5.0-30.0 wt % of the center layer, (ii) 30.0-80.0 wt % of the gum base layer, and (iii) 10.0-40.0 wt % of a coating layer.

3. The chewing gum of claim 2, wherein the gum base layer comprises 15-50 wt % of a gum base, 45-80 wt % of a sugar alcohol and a sweetener and 0.1-5.0 wt % of a flavor.

4. The chewing gum of claim 3, wherein the sugar alcohol is selected from the group consisting of xylitol, maltitol, sorbitol, erythritol, isomalt, lactitol, mannitol and a mixture thereof.

5. The chewing gum of claim 3, wherein the sweetener is selected from the group consisting of sugar, glucose, starch syrup and a mixture thereof.

6. (canceled)

7. The chewing gum of claim 2, wherein the coating layer comprises 60-95 wt % of a sugar alcohol, 0.1-5.0 wt % of a binding agent, 1.0-30 wt % of water and 0.1-5.0 wt % of a flavor.

8. A process of preparing a center-filled coated chewing gum, which comprises:
(a) obtaining a mixture by mixing a gum base layer composition comprising a gum base, a sweetener and a sugar alcohol in a mixer pre-heated at 45-55° C., adding a flavor in the composition and further mixing a mixture comprising the composition and the flavor;
(b) obtaining a molded gum by extruding the mixture with an extruder, hoppering paste-phase or granule-phase composition comprising 60-99 wt % of xylitol, 0-5.0 wt % of a cooling agent, 0.1-25 wt % of water, 0-5.0 wt % of menthol and 0-5.0 wt % of a flavor through a hopper with a screw, whereby enabling the filling of the center and the molding; and,
(c) coating the molded gum with a coating layer composition under the conditions of 18-25° C. and 40-50% RH, followed by aging.
